(19) United States
(12) Patent Application Publication
(10) Pub. No.: US 2026/0108859 A1
(43) Pub. Date: Apr. 23, 2026

(54) SYSTEM AND METHOD FOR PRODUCING GREEN UREA

(71) Applicants: thyssenkrupp Uhde GmbH, Dortmund (DE); thyssenkrupp AG, Essen (DE)

(72) Inventor: Ivo MUELLER, Dortmund (DE)

(73) Assignees: thyssenkrupp Uhde GmbH, Dortmund (DE); thyssenkrupp AG, Essen (DE)

(21) Appl. No.: 19/114,175

(22) PCT Filed: Sep. 21, 2023
(86) PCT No.: PCT/EP2023/076128

§ 371 Date: Mar. 21, 2025

(30) Foreign Application Priority Data
Sep. 23, 2022 (DE) 10 2022 210 053.0
Sep. 23, 2022 (LU) LU 103015

(51) Int. Cl. B01J 12/00; B01J 3/02; B01J 6/00; B01J 19/00; B01J 19/24; F02C 7/22; F02C 7/32

(52) U.S. Cl. CPC B01J 12/00; B01J 3/02; B01J 6/00; B01J 19/0013; B01J 19/2445; F02C 7/22; F02C 7/32; B01J 2219/00045; B01J 2219/00103; F05D 2220/76

(57) ABSTRACT

An apparatus for synthesizing urea comprises an ammonia source, a urea synthesis unit, wherein the ammonia source is connected to the urea synthesis unit via a reactant conduit, and an ammonia gas turbine, wherein the ammonia source is connected to the ammonia gas turbine via a fuel conduit and the ammonia gas turbine is connected to the urea synthesis unit via a steam conduit.

The invention relates to the production of green urea. More particularly, the invention relates to an apparatus for synthesizing urea having the features of claim 1.

The production of green chemicals is becoming increasingly important. The term “green” refers to chemicals that have been produced sustainably (and thus in a climate-neutral and environmentally friendly manner), so that no additional carbon dioxide is released into the atmosphere, particularly for their production. These may for example be chemicals produced in processes in which the production energy requirements are met by renewable (regenerative) energy sources (for example by electrical energy obtained from renewable energy sources, for instance in a photovoltaic plant, wind turbine, geothermal power plant or tidal power plant) and in which the reactants used for production are not obtained from fossil feedstocks. One area clearly in the spotlight here is the production of green ammonia, since the production of ammonia currently uses natural gas almost exclusively. In said production, carbon dioxide (CO₂) is produced as a by-product. If this carbon dioxide is not reused, it will be released into the environment. Urea plants are, however, able to utilize this carbon dioxide together with the ammonia for conversion into urea, which is used primarily as a fertilizer. The use of both product streams from the ammonia plant in the urea plant is one reason why these two plants are often fixedly integrated with one another. This integrated plant setup has the further advantage that, for example, steam can be exchanged between the two plants as an energy carrier. The carbon dioxide bound during urea production is ultimately released again when used in the field. Since this carbon dioxide comes from the natural gas used in ammonia production, the urea produced in this way is not green.

The production of urea from ammonia and CO₂ takes place on a large scale the world over and is known to those skilled in the art. One process is described in US 2018/0208551 A1.

EP 3 725 401 A1 discloses the use of renewable energy for the production of chemicals, wherein increased use is made of electricity instead of steam generated mostly with fossil energy sources.

CN 111378980 a discloses an energy storage system for the production of hydrogen and urea.

US 2019/0152901 A1 discloses a process for producing ammonia and urea therefrom in which a conventional gas turbine based on natural gas as fuel is used.

The production of ammonia and its further conversion into urea has up to now generally involved an integrated production facility. Ammonia is nowadays produced almost exclusively by the Haber-Bosch process. In this process, hydrogen and CO₂ are first produced from natural gas, with the thermal energy required likewise usually being generated using natural gas. This hydrogen is then subsequently reacted with nitrogen from the air to form ammonia. The Haber-Bosch process gives rise to steam as process waste heat, which can be utilized both for the ammonia production itself but also very readily for other processes too, for example a downstream urea process. The high steam requirement for the urea process arises from the steam turbine commonly employed in the CO₂ compressor that is required and also from the need to carry out multiple thermal separation processes in the synthesis.

Switching the synthesis of ammonia to a green synthesis route fundamentally alters its process characteristics. The first step in green synthesis is usually the production of hydrogen by electrolysis using renewably generated energy. Alternatively, direct electrochemical production of ammonia is also possible. CO₂ is consequently no longer formed as a by-product but is however needed as a feedstock for urea synthesis. Being independent of the natural gas feedstock hitherto used also makes it possible to transfer ammonia synthesis preferably to regions in which renewable energies are readily available (sunny desert regions, for example). A further discussion point in this context is that the ammonia thus generated, being a readily transportable storage medium for renewable energies, can also be utilized over relatively long distances. This makes use of the fact that ammonia is comparatively easy to liquefy (unlike hydrogen, for example) in order to obtain a liquid energy carrier having a high energy density.

Unlike ammonia, CO₂ is not so easy to transport over relatively long distances. It is therefore realistic to assume that new urea syntheses will in future be sited close to CO₂ sources that have been little used up to now or not used at all, for example waste incineration plants or cement production works. These sites may however be located a long way from ammonia syntheses. The challenge then arises that the steam (energy) normally provided by the ammonia synthesis is no longer present for urea production.

However, even if a green ammonia synthesis is operated directly in tandem with a urea synthesis, the lower steam output of said ammonia synthesis will no longer be enough to meet the energy demands of the urea synthesis.

The object of the invention is to provide a plant for producing green urea from green ammonia in which the urea synthesis is decoupled from the integrated plant hitherto used through a gray ammonia synthesis (for example, an ammonia synthesis, the reactants for which are provided using carbon-based fuels, more particularly using fossil fuels such as petroleum, natural gas, coal or constituents of the above, the reactants being obtained for example in a steam reformation or in an electrolysis using electricity generated from using said fuels).

This object is achieved by the apparatus having the features specified in claim 1. Advantageous developments will be apparent from the subclaims, the description that follows and the drawings.

The apparatus according to the invention is used for the synthesis of urea. The apparatus has an ammonia source and a urea synthesis unit. The urea synthesis unit is a customary urea synthesis unit known to those skilled in the art for the production of urea. The urea synthesis unit usually consists of a plurality of process steps and apparatuses, inter alia a urea reactor. The aim of the invention is, in particular, not to tinker with the actual process (and thus the plant) for the synthesis of urea but, rather, to design the connection to the environment such that the production process operates in accordance with the current state of the art even without it being connected to an ammonia synthesis apparatus operated with natural gas in particular. Ammonia source is for the purposes of the invention to be understood in broad terms. The ammonia source can be an ammonia synthesis apparatus. However, the ammonia source can also be a storage tank or a connection to an ammonia pipeline, for example. All that matters is that the ammonia source does not provide the urea synthesis unit with steam, or provides only insufficient steam, and no longer provides CO₂. The ammonia source is connected to the urea synthesis unit, more particularly to one or more apparatuses of the urea synthesis unit, via a reactant conduit. According to the invention, the apparatus includes an ammonia gas turbine. The ammonia source is connected to the ammonia gas turbine via a fuel conduit. The ammonia gas turbine is connected to the urea synthesis unit via a steam conduit.

An ammonia gas turbine is a gas turbine that is operated with ammonia as fuel gas (fuel). In the ammonia gas turbine, ammonia is burned with the formation of nitrogen and water, which are released into the environment. Such an ammonia gas turbine can provide both thermal energy and mechanical energy, which can be utilized in different ways for the urea synthesis unit. The ammonia gas turbine differs in construction and function as a gas turbine from turbines in which a hot gas flow already present is used to drive further units such as compressors (such a turbine is known for example from WO 2020/212926 A1, in which a urea synthesis employs a turbocharger for feeding carbamate that enables coupled feeding of ammonia and carbamate driven by liquid ammonia). More particularly, the ammonia gas turbine can be used to generate a hot gas flow, the kinetic energy of which can be utilized as driver for a compressor and/or a generator, in order for example to compress a process gas or to generate electrical energy. Ammonia gas turbines for industrial use are accordingly currently being built in order to permit the green energy carrier ammonia to be converted into electricity. For example, WO 2015/192877 A1 discloses the use of an ammonia gas turbine for power generation, wherein green ammonia is used as fuel gas. The ammonia gas turbine thus provides the energy necessary for the urea process, which accordingly no longer comes from a gray ammonia synthesis.

In the present case, ammonia is used as fuel gas in the ammonia gas turbine. Therefore, the ammonia source is not just connected to the urea synthesis unit via a reactant conduit, but also to the ammonia gas turbine via a fuel conduit. The ammonia gas turbine is also connected to the urea synthesis unit via a steam conduit; this can be especially realized in such a way that the waste heat generated in the ammonia gas turbine is utilized to produce steam in a downstream heat exchanger (the steam can of course also come from a heat exchanger downstream of the actual combustion process), which can be supplied to the urea synthesis unit via a steam conduit in order to utilize the thermal energy of the steam in the urea synthesis unit, for example to heat the reaction mixture to the required temperature.

The use of green ammonia as an energy supplier has the advantage that there is no need for renewable energy production to be provided at the site of the apparatus or for it to be reliably present there. Since the combustion of green ammonia generates CO₂-free energy, this allows green energy to be provided for urea synthesis in a simple manner. This combustion of gaseous ammonia can take place efficiently in gas turbines, the space required for this being much smaller than for other renewable energy suppliers, such as a wind farm and/or a photovoltaic plant.

The use of green ammonia both as a feedstock for urea synthesis and for the production of green energy, for example of electricity or steam, in combination with the use of carbon dioxide coming from other sources, means that the urea produced in this way can be described as green in the sense of CO₂-neutral.

In a further embodiment of the invention, the ammonia gas turbine is connected via a further steam conduit to a Haber-Bosch reactor for ammonia synthesis. More particularly, the steam generated in the Haber-Bosch process is superheated in the ammonia gas turbine and then supplied to the urea reactor. For this purpose, the ammonia gas turbine preferably has a heat exchanger in which the steam is heated further with the combustion off-gases, more particularly the off-gases from ammonia combustion. The steam can be used in the urea synthesis unit as a heat-transfer medium, i.e. in just one or more of the heat exchangers of the urea reactor, for example. The steam thus serves only as a heat-transfer medium.

In a further embodiment of the invention, the ammonia gas turbine is designed to directly drive a CO₂ compressor. In off-gas scrubbing or in biogas plants, for example, CO₂ is produced at approximately ambient pressure. For urea synthesis, the CO₂ must be compressed to e.g. 150 bar. The direct coupling achieves a double use of the ammonia gas turbine: the waste heat is utilized directly in the process and the mechanical power is utilized for compressing the CO₂.

In a further embodiment of the invention, the ammonia gas turbine is connected in a force-fitting manner to a generator. The ammonia gas turbine thus drives the generator, thereby allowing electricity to be generated through the combustion of ammonia. The generator is electrically connected to the urea synthesis unit. This combination has the advantage that it constitutes a reliable electricity source for the rest of the infrastructure. This is the case particularly when green ammonia is used to produce green electricity, since other renewable energy sources such as solar and electricity may be subject to fluctuations.

In a further embodiment of the invention, the generator is electrically connected to the CO2 compressor.

When the gas turbine/compressor speeds and generator speeds are different, power transmission between the two machines can be effected via a gearbox.

Depending on the operating state, the combustion of ammonia can result in the formation of nitrogen oxides in the gas turbine, which must be removed in a subsequent off-gas treatment.

Those skilled in the art will be familiar with common methods for this, such as selective catalytic reduction.

In a further embodiment of the invention, the ammonia gas turbine is connected in a force-fitting manner to the CO₂ compressor. More particularly, the ammonia gas turbine and the CO₂ compressor may be arranged on the same shaft, which may optionally include a gearbox. In this embodiment, the ammonia gas turbine mechanically drives the CO₂ compressor directly, with the result that energy losses, for example during power generation and electrical operation of the CO₂ compressor, can be avoided.

A further embodiment of the invention includes a thermal splitting apparatus (thermal cracking apparatus). The thermal splitting apparatus is designed to split ammonia into hydrogen and nitrogen. The thermal splitting apparatus is connected to the ammonia source. This supplies ammonia to the splitting apparatus. The thermal splitting apparatus is connected to the ammonia gas turbine. Since the ammonia combustion process can itself be subject to fluctuations, hydrogen is admixed for more stable combustion in some variants of the ammonia gas turbine. For said splitting, it is helpful that nitrogen and hydrogen are in an equilibrium with ammonia that at low pressure can be shifted in favor of the elements.

In a further embodiment of the invention, the apparatus includes a hydrogen source. For the purposes of the invention, a hydrogen source can be, for example, a hydrogen electrolysis apparatus, a hydrogen tank or the connection to a piped hydrogen supply. The hydrogen source is connected to the ammonia gas turbine via a hydrogen conduit. This allows a certain amount of hydrogen to be metered into the ammonia, so that more stable combustion is possible.

In a further embodiment of the invention, the ammonia gas turbine is connected to the thermal splitting apparatus via a heat conduit. The waste heat from the ammonia gas turbine is accordingly utilized to at least partially decompose ammonia back to hydrogen and nitrogen.

The apparatus according to the invention is more particularly elucidated hereinbelow with reference to exemplary embodiments shown in the drawings.

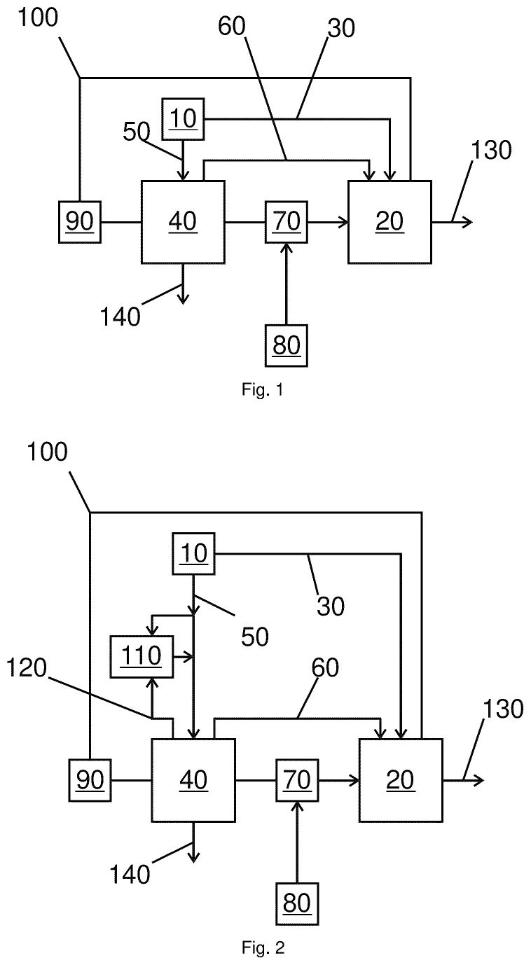

FIG. 1: First embodiment

FIG. 2: Second embodiment

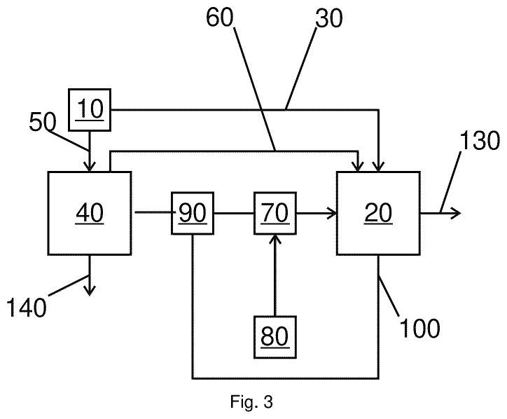

FIG. 3: Third embodiment

FIG. 1 shows a first embodiment of the apparatus according to the invention. The apparatus is preferably located close to a suitable CO₂ source 80. The CO₂ source 80 can for example be a waste incineration plant, a biogas plant or a direct air-capture process. Since the ammonia produced for the production of green urea is not specifically being produced from natural gas, the CO₂ source is not, as was formerly the case, an ammonia synthesis apparatus. The apparatus further includes an ammonia source 10. The ammonia source 10 can theoretically be an ammonia synthesis apparatus. However, the latter makes sense only if there is sufficient renewable energy for the production of green ammonia at this site as well as a suitable CO₂ source 80 for urea production. This cannot however be assumed in all cases; on the contrary, it is to be expected that this will not be the case. Ammonia will consequently be transported from the ammonia synthesis apparatus to users, for example the apparatus according to the invention. The ammonia source 10 can therefore also be a storage tank or a connection to an ammonia pipeline.

Ammonia is supplied from the ammonia source 10 to the urea synthesis unit 20 via a reactant conduit 30. Similarly, the carbon dioxide from the CO2 source 80 is supplied to an apparatus of the urea synthesis unit 20 via a CO₂ compressor 70 in which the carbon dioxide is brought to the pressure required for urea synthesis. In the urea synthesis unit 20, carbon dioxide and ammonia are reacted to form urea. The urea exits the urea synthesis unit 20 as product and is supplied, for example, to a granulation apparatus, optionally after first being mixed with other components.

To provide the necessary energy, the apparatus includes an ammonia gas turbine 40. The ammonia gas turbine 40 is connected to the ammonia source 10 via a fuel conduit 50. If it is green ammonia produced in the ammonia gas turbine 40 that is being reacted, the energy thus generated will likewise be CO₂ emissions-free. When ammonia is burned, only nitrogen and water are formed and released into the environment.

The ammonia gas turbine 40 is connected in a force-fitting manner to the CO₂ compressor 70, more particularly they are both arranged on the same shaft, which may optionally include a gearbox. As a result, the ammonia gas turbine 40 drives the CO₂ compressor 70 directly. At the same time, the waste heat generated in the ammonia gas turbine 40 is utilized to produce steam in a downstream heat exchanger, which is supplied to the urea synthesis unit 20 via a steam conduit 60. In this case, the steam can also come from a heat exchanger downstream of the actual combustion process.

As shown here, the ammonia gas turbine 40 can optionally additionally also be connected in a force-fitting manner to a generator 90. The electrical energy generated therein can be provided to the urea synthesis unit 20 via an electrical connection 100.

FIG. 2 shows a second embodiment that, in addition to the first embodiment, includes a thermal splitting apparatus 110. The thermal splitting apparatus 110 is fed with the waste heat of the ammonia gas turbine 40 via a heat conduit 120. A portion of the ammonia from the ammonia source 10 is supplied to the thermal splitting apparatus 110 and the mixture of ammonia, hydrogen and nitrogen produced is supplied to the ammonia gas turbine 40. The additional hydrogen results in more stable combustion in the ammonia gas turbine 40.

FIG. 3 shows a third embodiment, which differs from the first embodiment shown in FIG. 1 in that the ammonia gas turbine 40 is only connected in a force-fitting manner to the generator 90, more particularly is arranged on the same shaft. The generator 90 is connected via an electrical connection to the CO₂ compressor 70, which is accordingly operated purely electrically. The advantage of this embodiment is the optimal operating mode of the ammonia gas turbine 40 for the generator 90, which makes it easier to respond to a fluctuating electricity requirement, for example in the urea synthesis unit 20, and to respond independently of the CO₂ gas flow to be compressed.

### Reference Signs

10 Ammonia source
20 Urea synthesis unit
30 Reactant conduit
40 Ammonia gas turbine
50 Fuel conduit
60 Steam conduit
70 CO₂ compressor
80 CO₂ source
90 Generator
100 Electrical connection
110 Thermal splitting apparatus
120 Heat conduction
130 Product outlet
140 Off-gas

1-7. (canceled)

8. An apparatus for synthesizing urea, comprising:
an ammonia source;
a urea synthesis unit, wherein the ammonia source is connected to the urea synthesis unit via a reactant conduit; and
ammonia gas turbine, wherein the ammonia source is connected to the ammonia gas turbine via a fuel conduit and the ammonia gas turbine is connected to the urea synthesis unit via a steam conduit.

9. The apparatus as claimed in claim 8, wherein the ammonia gas turbine is designed to drive a CO₂ compressor.

10. The apparatus as claimed in claim 8, wherein the ammonia gas turbine is connected in a force-fitting manner to a generator, the generator being electrically connected to the urea synthesis unit.

11. The apparatus as claimed in claim 10, wherein the generator is electrically connected to the CO₂ compressor.

12. The apparatus as claimed in claim 8, wherein the ammonia gas turbine is connected in a force-fitting manner to the CO₂ compressor.

13. The apparatus as claimed in claim 8, further comprising a thermal splitting apparatus, the thermal splitting apparatus being designed for converting ammonia into hydrogen and nitrogen, wherein the thermal splitting apparatus is connected to the ammonia source and wherein the thermal splitting apparatus is connected to the ammonia gas turbine.

14. The apparatus as claimed in claim 13, wherein the ammonia gas turbine is connected to the thermal splitting apparatus via a heat conduit.
